(19) United States
(12) Patent Application Publication
(10) Pub. No.: US 2006/0005593 A1
(43) Pub. Date: Jan. 12, 2006

(54) Biological compound fertilizer

(76) Inventor: Frederic Paquin, Quebec (CA)

Correspondence Address: Mr. Frederic Paquin, 17 rue principale, St-Gilbert, Portneuf, QC, GOA 4BO, CA

(21) Appl. No.: 10/885,560

(22) Filed: Jul. 7, 2004

(51) Int. Cl. C05F 3/00

(52) U.S. Cl. 71/21

(57) ABSTRACT

The present invention provides a biological compound fertilizer based on pure organic matter, which is used for plant nutrition and soil fertility, and which its application has no environmental pollution and impact on ecological environment.

### BACKGROUND OF THE INVENTION

1. Field of the Invention

The present invention relates to a high-effective biological compound fertilizer based on pure organic matter, which is used for plant nutrition and soil fertility.

2. Description of the Related Art

A search of prior art records has unveiled the following patents:

1. CN 1,094,387 issued in 1994 to Xing Fu;

2. CN 1,076,682 issued in 1993 to Yushui Shen;

3. CN 1,229,776 issued in 1999 to Deng Chunqing;

4. CN 1,275,550 issued in 2000 to JiangFengge;

5. U.S. Pat. No. 6,517,600 issued in 2003 to Dinel Henri;

6. CN 1,332,134 issued in 2002 to Xu Huamei;

7. CN 1,347,859 issued in 2002 to Dong Lianshun;

8. CN 1,298,852 issued in 2001 to Cui Jinshu;

9. CN 1,076,683 issued in 1993 to Shiyuan Qin; and

10. CA 2,419,599 issued in 2002 to Zhang Lingyu.

The patents mentioned above are probably the most relevant.

As is well known, the organic fertilizers come from many different sources.

It is therefore an object of the invention to provide a biological compound fertilizer based on pure organic matter, and which may be used for green plants, flowering plants, conifers, flowering trees and shrubs, vegetables and lawn.

### SUMMARY OF THE INVENTION

The present invention relates to a high-effective biological compound fertilizer based on pure organic matter, which is used for plant nutrition and soil fertility, and which its application has no environmental pollution and impact on ecological environment.

### DETAILED DESCRIPTION OF THE PREFERRED EMBODIMENTS

Referring to table, the biological compound fertilizer is a liquid that is constituted of a mixture of organic matters.

In particular, the guano has been added to the above-mentioned compound fertilizer for improving and protecting the soil structure.

Furthermore, in regulating its pH (see table) it prevent the destruction of the microbial flora that is necessary to the plants growth.

Additionally, the compound fertilizer includes also an essential oil (lippia citriodora) enabling to put far various types of insect which can harm to the plants and nurseryman, and that without damage the ecosystems.

Finally, these beneficial effects of the compound fertilizer are accomplished by using the combinations of organic compounds already known.

Experimentation: (Tested Concentration)

TABLE

| | | | | Concentration | Water | |
|---|---|---|---|---|---|---|
| Species | pH | Nitrogen | Phosphorus | Potassium | Quantity/l. | Quantity/240 l. |
| Green plant | 6.5 | 8 | 1 | 2 | 0.76185 | 182.85 |
| Flowering | 6.5 | 5 | 10 | 10 | 0.41685 | 100.17 |
| plant | | | | | | |
| African | 6.5 | 3 | 8 | 10 | 0.52185 | 125.34 |
| violet | | | | | | |
| Cactus | 6.5 | 5 | 10 | 6 | 0.48385 | 116.17 |
| Bonsai | 6.0 | 2 | 2 | 3 | 0.84485 | 202.74 |
| Orchid | 6.5 | 5 | 10 | | 0.50085 | 120.17 |
| Rododendron | 5.5 | 5 | 8 | 5 | 0.47785 | 114.74 |
| Azalea | | | | | | |
| Rose-tree | 6.2 | 5 | 8 | 10 | 0.47885 | 114.87 |
| Tomato and | 6.2 | 5 | 7 | 10 | 0.54285 | 130.24 |
| Fruit | | | | | | |
| Vegetable | 6.5 | 5 | 10 | 8 | 0.41685 | 100.17 |
| Transplantation | 6.5 | 1 | 9 | 10 | 0.63485 | 152.41 |
| Fertilizer | | | | 4 | Garden | |
| | | | | | compost | |
| Lawn 1 | 6.5 | 11 | 2 | 2 | 0.60785 | 9.12 |
| Lawn 2 | 6.5 | 10 | 2 | 2 | 0.62985 | 9.45 |
| Lawn 3 | 6.5 | 4 | 2 | 8 | 0.65985 | 9.90 |
| Cedar | 5.5 | 10 | 2 | 4 | 0.59685 | 8.95 |

| Prickly Nettle | Guano (bat) |
|---|---|
| 46-0-0 | 0.32-32, 3-0.06 |

| Quantity/l. | Quantity/240 l. | Quantity/l. | Quantity/240 l. |
|---|---|---|---|
| 0.174 | 41.7 | 0.031 | 7.4 |
| 0.107 | 25.6 | 0.310 | 74.3 |
| 0.063 | 15.2 | 0.248 | 59.4 |
| 0.107 | 25.6 | 0.310 | 74.3 |
| 0.043 | 10.3 | 0.062 | 14.9 |
| 0.107 | 25.6 | 0.310 | 74.3 |
| 0.107 | 25.7 | 0.248 | 59.4 |
| 0.107 | 25.7 | 0.248 | 59.4 |
| 0.107 | 25.7 | 0.217 | 52.0 |
| 0.107 | 25.6 | 0.310 | 74.3 |
| 0.020 | 4.8 | 0.279 | 66.9 |
| 0.234 | 3.5 | 0.125 | 1.9 |
| 0.212 | 3.2 | 0.125 | 1.9 |
| 0.082 | 1.2 | 0.125 | 1.9 |
| 0.212 | 3.2 | 0.125 | 1.9 |

| | | |
|---|---|---|
| | | Oil (vervain) |
| Potassium | Phosphoric | (Lippia |
| muriate | acid | Citriodora) |

0-0-60

| Quantity/l. | Quantity/240 l. | Quantity/l. | Quantity/240 l. | Quantity/l. | Quantity/240 l. |
|---|---|---|---|---|---|
| 0.033 | 8.0 | 0 | 0.000 | 0.00015 | 0.035 |
| 0.166 | 39.9 | 0 | 0.000 | 0.00015 | 0.035 |
| 0.166 | 39.9 | 0 | 0.000 | 0.00015 | 0.035 |
| 0.100 | 23.9 | 0 | 0.000 | 0.00015 | 0.035 |
| 0.050 | 12.0 | 0.0002 | 0.048 | 0.00015 | 0.035 |
| 0.083 | 19.9 | 0 | 0.000 | 0.00015 | 0.035 |
| 0.166 | 39.9 | 0.0007 | 0.168 | 0.00015 | 0.035 |
| 0.166 | 39.9 | 0.00015 | 0.036 | 0.00015 | 0.035 |
| 0.133 | 31.9 | 0.00015 | 0.036 | 0.00015 | 0.035 |
| 0.166 | 39.9 | 0 | 0.000 | 0.00015 | 0.035 |
| 0.066 | 15.9 | 0 | 0.000 | 0.00015 | 0.035 |
| 0.033 | 0.5 | | | 0.00015 | 0.035 |
| 0.033 | 0.5 | | | 0.00015 | 0.035 |
| 0.133 | 2.0 | | | 0.00015 | 0.035 |
| 0.067 | 1.0 | 0.0007 | 0.168 | 0.00015 | 0.035 |

Discuss:

The results obtained are very satisfactory.

Although only a single embodiment of the present invention has been described and illustrated, the present invention is not limited to the features of this embodiment, but includes all variations and modifications within the scope of claims.

I claim: The embodiments of the invention for which an exclusive property or privilege is claimed, are defined as follows:

1. A biological compound fertilizer based on pure organic matter, which is used for plant nutrition and soil fertility, and which its application has no environmental pollution and impact on ecological environment.

2. A biological compound fertilizer as defined in claim 1, is a liquid constituted of a mixture of organic matters that differs depending on the species.

3. A biological compound fertilizer as defined in claim 1 or 2 which is constituted of a mixture of organic matters including an essential oil (lippia citriodora) that allows to put far various types of insect which can harm to the plants and nurseryman, wherein the quantity of water per litre to be used differs from 0,1 to 0,00015 depending on the quantity of essential oil to be used.
